(19) United States
(12) Patent Application Publication
(10) Pub. No.: US 2014/0067230 A1
(43) Pub. Date: Mar. 6, 2014

(54) TWO-STAGE TURBOCHARGER CONTROL SYSTEMS AND METHODS

(71) Applicants: Zhiping Steven Liu, Canton, MI (US); Kevin Andrew Gady, Saline, MI (US); Yue-Yun Wang, Troy, MI (US)

(72) Inventors: Zhiping Steven Liu, Canton, MI (US); Kevin Andrew Gady, Saline, MI (US); Yue-Yun Wang, Troy, MI (US)

(73) Assignee: GM Global Technology Operations LLC, Detroit, MI (US)

(21) Appl. No.: 13/605,197

(22) Filed: Sep. 6, 2012

(51) Int. Cl. F02B 37/12

(52) U.S. Cl. 701/102

(57) ABSTRACT

A turbocharger control method includes: determining a first desired pressure ratio across a first compressor of a first turbocharger; based on the first desired pressure ratio, determining a first desired duty cycle for a first wastegate of the first turbocharger; determining a second desired pressure ratio across a second compressor of a second turbocharger based on the first desired pressure ratio; based on the second desired pressure ratio, determining a second desired duty cycle for a second wastegate of the second turbocharger; generating a first target duty cycle for the first wastegate based on the first desired duty cycle; opening the first wastegate based on the first target duty cycle; generating a second target duty cycle for the second wastegate based on the second desired duty cycle; and opening the second wastegate based on the second target duty cycle.

### FIELD

The present disclosure relates to engine control systems and methods and more particularly to control systems and methods for engines with two-stage turbochargers.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into gasoline engines is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders. Increasing the amount of air and fuel provided to the cylinders increases the torque output of the engine.

Engine control systems have been developed to control engine torque output to achieve a desired torque. Traditional engine control systems, however, do not control the engine torque output as accurately as desired. Further, traditional engine control systems do not provide a rapid response to control signals or coordinate engine torque control among various devices that affect the engine torque output.

### SUMMARY

A turbocharger control system of a vehicle is disclosed. A first duty cycle determination module determines a first desired pressure ratio across a first compressor of a first turbocharger and, based on the first desired pressure ratio, determines a first desired duty cycle for a first wastegate of the first turbocharger. A second duty cycle determination module determines a second desired pressure ratio across a second compressor of a second turbocharger based on the first desired pressure ratio and, based on the second desired pressure ratio, determines a second desired duty cycle for a second wastegate of the second turbocharger. A first targeting module generates a first target duty cycle for the first wastegate of the first turbocharger based on the first desired duty cycle and opens the first wastegate of the first turbocharger based on the first target duty cycle. A second targeting module generates a second target duty cycle for the second wastegate of the second turbocharger based on the second desired duty cycle and opens the second wastegate of the second turbocharger based on the second target duty cycle.

A turbocharger control method of a vehicle is also disclosed. The turbocharger control method includes: determining a first desired pressure ratio across a first compressor of a first turbocharger; based on the first desired pressure ratio, determining a first desired duty cycle for a first wastegate of the first turbocharger; determining a second desired pressure ratio across a second compressor of a second turbocharger based on the first desired pressure ratio; based on the second desired pressure ratio, determining a second desired duty cycle for a second wastegate of the second turbocharger; generating a first target duty cycle for the first wastegate of the first turbocharger based on the first desired duty cycle; opening the first wastegate of the first turbocharger based on the first target duty cycle; generating a second target duty cycle for the second wastegate of the second turbocharger based on the second desired duty cycle; and opening the second wastegate of the second turbocharger based on the second target duty cycle.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the present application;

FIG. 2 is a functional block diagram of a portion of an example engine control module according to the present application;

FIG. 3 is a flowchart depicting an example method of determining a feed-forward value for controlling a low pressure turbocharger according to the present application;

FIG. 4 is a flowchart depicting an example method of determining a feed-forward value for controlling a high pressure turbocharger according to the present application; and

FIG. 5 is a flowchart depicting an example method of controlling the low and high pressure turbochargers according to the present application.

### DETAILED DESCRIPTION

An engine combusts an air/fuel mixture to generate drive torque for a vehicle. A turbocharger provides compressed air to the engine. In two-stage turbocharger systems, two turbochargers provide compressed air to the engine. The ability to provide compressed air to the engine may enable the engine to produce a greater range of torque than the engine would otherwise be able to achieve.

The turbochargers of a two-stage turbocharger system can be controlled in combination to achieve a desired level of compression of the air. However, the contributions of the turbochargers can be controlled in multiple different ways to achieve one desired level of compression. The present application involves control systems and methods for controlling two-stage turbocharger systems to maximize system efficiency, provide protection for components, and minimize the period for responding to a change in desired engine torque output.

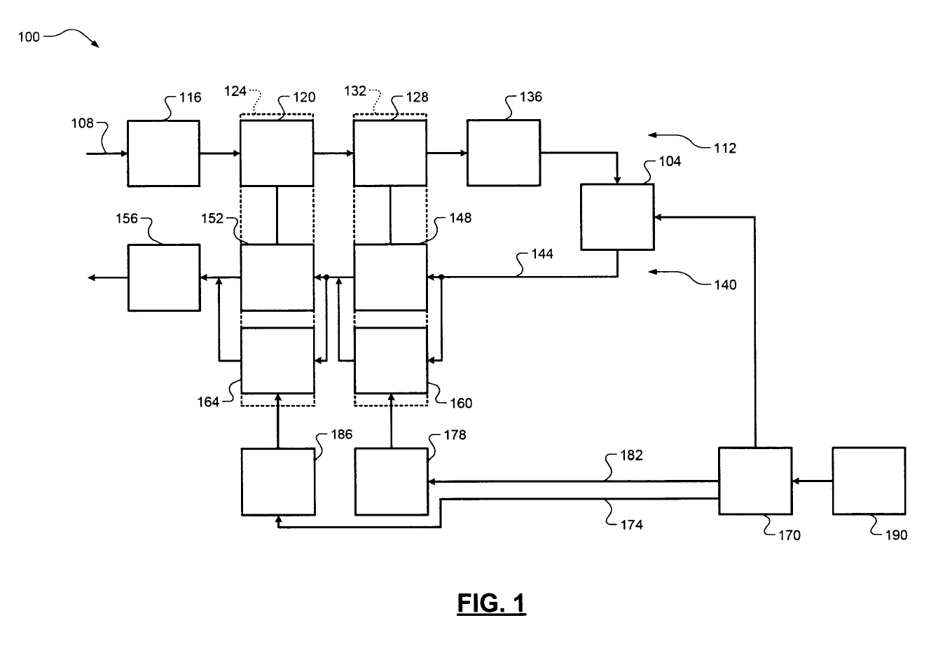

Referring now to FIG. 1, a functional block diagram of an example engine system 100 of a vehicle is presented. An engine 104 combusts an air/fuel mixture within cylinders to produce torque. The engine 104 may include, for example, a spark ignition direct injection (SIDI) engine or another suitable type of internal combustion engine. The vehicle may include one or more electric motors and/or motor generators for propulsion.

Air 108 flows into the engine 104 via an intake system 112. The intake system 112 includes an air filter 116, a low pressure (LP) compressor 120 of a LP turbocharger 124, a high pressure (HP) compressor 128 of a HP turbocharger 132, and an air cooler 136. While not specifically shown, the intake system 112 also includes connecting devices (e.g., pipes) that connect the components of the intake system 112 together. The intake system 112 may also include other components, such as one or more throttle valves, an intake manifold, etc.

The air 108 flowing into the engine 104 may encounter the components of the intake system 112 in the following order: first, the air filter 116; second, the LP compressor 120; third, the HP compressor 128; and fourth, the air cooler 136. The air filter 116 filters particulate from air flowing into the intake system 112.

The LP compressor 120 receives air that flows through the air filter 116 and compresses the air to a first pressure. The HP compressor 128 receives the compressed air from the LP compressor 120 and further compresses the air. The HP compressor 128 outputs compressed air to the air cooler 136. Compression of the air generates heat. The air may also absorb heat from one or more other heat sources, such as an exhaust system 140. The air cooler 136 cools the compressed air and provides the cooled compressed air to the engine 104. The engine 104 combusts air and fuel to generate torque for propulsion.

The engine 104 outputs exhaust 144 resulting from combustion of air and fuel to the exhaust system 140. The exhaust system 140 includes a HP turbine 148, a LP turbine 152, a catalyst 156, a HP wastegate 160, and a LP wastegate 164. While not specifically shown, the exhaust system 140 also includes connecting devices (e.g., pipes) that connect the components of the exhaust system 140 together. The exhaust system 140 may also include other components, such as an exhaust manifold, one or more other catalysts, a particulate filter, etc.

Exhaust gas traveling through the exhaust system 140 may encounter the components of the exhaust system 140 in the following order: first, the HP turbine 148 or the HP wastegate 160; second, the LP turbine 152 or the LP wastegate 164; third, the catalyst 156. The HP turbine 148 is mechanically coupled to the HP compressor 128. Exhaust flow through the HP turbine 148 drives rotation of the HP turbine 148. Rotation of the HP turbine 148 causes rotation of the HP compressor 128. The HP wastegate 160 is actuated to regulate exhaust bypassing the HP turbine 148. As the amount of exhaust bypassing the HP turbine 148 through the HP wastegate 160 increases, boost (e.g., compression of air) provided by the HP compressor 128 decreases, and vice versa.

The LP turbine 152 is mechanically coupled to the LP compressor 120. Exhaust flow through the LP turbine 152 drives rotation of the LP turbine 152. Rotation of the LP turbine 152 causes rotation of the LP compressor 120. The LP wastegate 164 is actuated to regulate exhaust bypassing the LP turbine 148. As the amount of exhaust bypassing the LP turbine 152 through the LP wastegate 164 increases, boost (e.g., compression of air) provided by the LP compressor 120 decreases, and vice versa. The catalyst 156 reacts with one or more components of the exhaust before the exhaust is expelled from the vehicle. For example only, the catalyst 156 may include a three-way catalyst, a four-way catalyst, or another suitable type of catalyst.

An engine control module (ECM) 170 controls operation of the engine 104, for example, based on a driver torque request. The ECM 170 controls the LP and HP turbochargers 124 and 132 via the LP and HP wastegates 164 and 160, respectively. More specifically, the ECM 170 determines a target duty cycle 182 (HP DC) to be applied to the HP wastegate 160, and a HP wastegate actuator module 178 applies a signal to the HP wastegate 160 at the target duty cycle 182. The ECM 170 also determines a target duty cycle 174 (LP DC) to be applied to the LP wastegate 164, and a LP wastegate actuator module 186 applies a signal to the LP wastegate 164 at the target duty cycle 174. By controlling the flow of exhaust through the LP and HP wastegates 164 and 160, the ECM 170 controls rotational speed of the LP and HP turbines 152 and 148 and therefore the boost provided by the LP and HP compressors 120 and 128, respectively.

One or more sensors, collectively illustrated by 190, may be implemented. For example, the sensors 190 may include a LP wastegate opening sensor that measures an opening of the LP wastegate 164, inlet and outlet temperature sensors, component temperature sensors, inlet and outlet pressure sensors, mass flow rate sensors, etc.

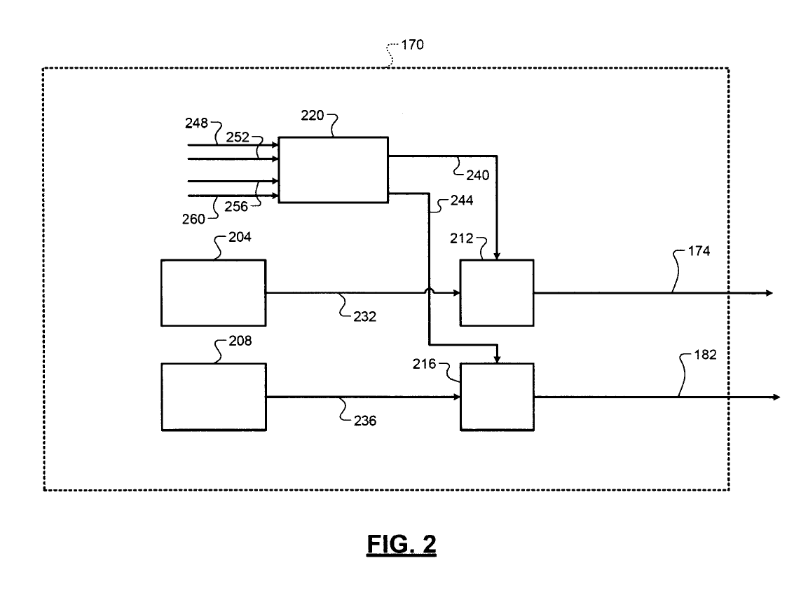

Referring now to FIG. 2, a functional block diagram of a portion of an example implementation of the ECM 170 is presented. The ECM 170 includes a LP duty cycle (DC) determination module 204, a HP DC determination module 208, a LP targeting module 212, a HP targeting module 216, and an adjustment determination module 220.

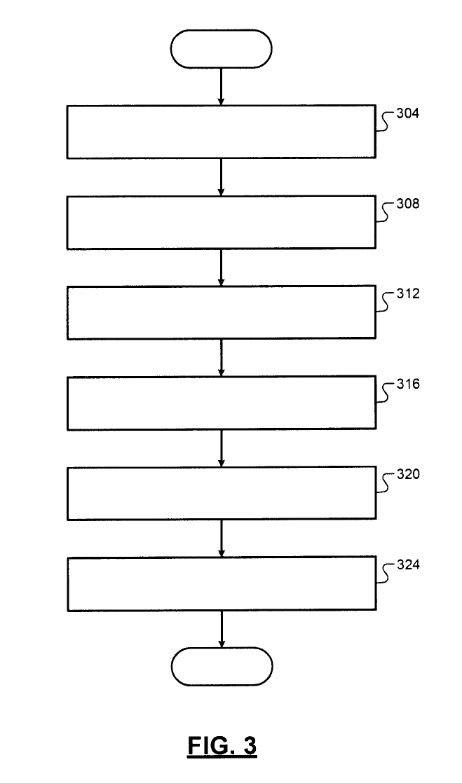

The LP DC determination module 204 determines a feed-forward (FF) LP duty cycle (DC) 232 for controlling the LP wastegate 164 (and therefore the LP turbocharger 124). FIG. 3 includes a flowchart depicting an example method of determining the FF LP DC 232 that may be performed by the LP DC determination module 204. Referring now to FIGS. 2 and 3, at 304, the LP DC determination module 204 may determine a desired pressure ratio across the LP compressor 120, a desired efficiency of the LP compressor 120, and a desired speed of the LP compressor 120. The LP DC determination module 204 may determine the desired pressure ratio across the LP compressor 120, the desired efficiency of the LP compressor 120, and the desired speed of the LP compressor 120 based on a desired mass air flowrate into the engine 104, a temperature at an inlet of the LP compressor 120, and a pressure at an inlet of the LP compressor 120.

For example, the LP DC determination module 204 may determine the desired pressure ratio across the LP compressor 120, the desired efficiency of the LP compressor 120, and the desired speed of the LP compressor 120 using the relationships:

$${PR}_{LPC , DES} = f ( {\dot{m}}_{SYS . DES} * \frac{\sqrt{{T}_{LPC , IN}}}{{p}_{LPC , IN}} ) ;$$

$${η}_{LPC , DES} = f ( {\dot{m}}_{SYS , DES} * \frac{\sqrt{{T}_{LPC , IN}}}{{p}_{LPC , IN}} ) ;$$

$$and$$

$${ω}_{LPC , DES} = f ( {\dot{m}}_{SYS , DES} * \frac{\sqrt{{T}_{LPC , IN}}}{{p}_{LPC , IN}} ) ,$$

where PR_{LPC,DES} is the desired pressure ratio across the LP compressor 120, η_{LPC,DES} is the desired efficiency of the LP compressor 120, ω_{LPC,DES} is the desired speed of the LP compressor 120, \dot{m}_{SYS,DES} is the desired mass air flowrate into the engine 104, T_{LPC,IN} is the temperature at the inlet of the LP compressor 120, and p_{LPC,IN} is the pressure at the inlet of the LP compressor 120. The temperature and the pressure at the inlet of the LP compressor 120 may be measured using sensors or determined based on one or more other parameters. The desired mass air flowrate into the engine 104 may be determined, for example, from a function that relates a requested torque output of the engine 104 to the desired mass air flowrate into the engine 104. The requested torque output of the engine 104 may be determined, for example, based on driver inputs.

At 308, the LP DC determination module 204 determines a desired power input to the LP compressor 120. The LP DC determination module 204 determines the desired power input to the LP compressor 120 based on the desired mass air flowrate into the engine 104, the desired efficiency of the LP compressor 120, the temperature at the inlet of the LP compressor 120, the desired pressure ratio across the LP compressor 120, a specific heat ratio, and a specific heat of the air input to the LP compressor 120. For example, the LP DC determination module 204 may determine the desired power input to the LP compressor 120 using the relationship:

$${PWR}_{LPC , DES} = {\dot{m}}_{SYS , DES} * {Cp}_{LPC , IN} * {T}_{LPC , IN} * \frac{1}{{η}_{LPC , DES}} * ( {( {PR}_{LPC , DES} )}^{\frac{γ - 1}{γ}} - 1 ) ,$$

where PWR_{LPC,DES} is the desired power input to the LP compressor 120, Cp_{LPC,IN} is the specific heat of the air input to the LP compressor 120, γ (gamma) is the specific heat ratio, PR_{LPC,DES} is the desired pressure ratio across the LP compressor 120, \dot{m}_{SYS,DES} is the desired mass air flowrate into the engine 104, and T_{LPC,IN} is the temperature at the inlet of the LP compressor 120. The specific heat of the air input to the LP compressor 120 and the specific heat ratio may be fixed, calibrated values or may be variable values.

At 312, the LP DC determination module 204 determines a desired power of the LP turbine 152 corresponding to the desired power input to the LP compressor 120. The LP DC determination module 204 determines the desired power of the LP turbine 152 based on the desired power input to the LP compressor 120, the desired speed of the LP compressor 120, a desired acceleration of the LP compressor 120, a mechanical efficiency of the LP turbine 152, a thermal efficiency of the LP turbine 152, and an inertia of LP turbine 152. For example, the LP DC determination module 204 may determine the desired power of the LP turbine 152 using the relationship:

$${PWR}_{LPT , DES} = \frac{1}{{η}_{LPT , MECH}} * ( {PWR}_{LPC , DES} + {J}_{LPT} * {ω}_{LPC , DES} * {a}_{LPC , DES} ) ,$$

where PWR_{LPT,DES} is the desired power of the LP turbine 152, η_{LPT,MECH} is the first mechanical efficiency of the LP turbine 152, J_{LPT} is the inertia of the LP turbine 152, ω_{LPC,DES} is the desired speed of the LP compressor 120, and a_{LPC,DES} is the desired acceleration of the LP compressor 120. The desired acceleration of the LP compressor 120 may be determined, for example, based on time derivative of the desired speed of the LP compressor 120. The mechanical and thermal efficiencies of the LP turbine 152 may be fixed, calibrated values or variable values (e.g., determined based on temperature of the LP turbine 152). The mechanical efficiency represents the power lost to friction to spin the shaft.

The LP DC determination module 204 determines a desired mass flowrate through the LP turbine 152 corresponding to the desired power of the LP turbine 152 at 316. The LP DC determination module 204 determines the desired mass flowrate through the LP turbine 152 based on the desired power of the LP turbine 152, a specific heat of the gas at the inlet of the LP turbine 152, a temperature at the inlet of the LP turbine 152, an efficiency of the LP turbine 152, a pressure ratio across the LP turbine 152, and a specific heat ratio.

For example, the LP DC determination module 204 may determine the desired mass flowrate through the LP turbine 152 using the relationship:

$${\dot{m}}_{LPT , DES} = {{PWR}_{LPT , DES} [ {Cp}_{LPT , IN} * {T}_{LPT , IN} * {η}_{LPT} * ( 1 - {( {PR}_{LPT} )}^{\frac{γ - 1}{γ}} ) ]}^{- 1} ,$$

where \dot{m}_{LPT,DES} is the desired mass flowrate through the LP turbine 152, PWR_{LPT,DES} is the desired power of the LP turbine 152, Cp_{LPT,IN} is the specific heat of the gas input to the LP turbine 152, T_{LPT,IN} is the temperature of the gas at the inlet of the LP turbine 152, PR_{LPT} is the pressure ratio across the LP turbine 152, and γ (gamma) is the specific heat ratio. The specific heat of the gas input to the LP turbine 152 and the specific heat ratio may be fixed, calibrated values or may be variable values. The pressure ratio across the LP turbine 152 may be determined based on a pressure at the inlet of the LP turbine 152 and a pressure at the outlet of the LP turbine 152. The pressure at the inlet of the LP turbine 152, the pressure at the outlet of the LP turbine 152, and the temperature at the inlet of the LP turbine 152 may be measured using sensors or determined based on one or more other parameters.

At 320, the LP DC determination module 204 determines a desired mass flowrate through the LP wastegate 164. The LP DC determination module 204 determines the desired mass flowrate through the LP wastegate 164 based on the desired mass flowrate through the LP turbine 152 and a mass flowrate of the engine 104 (e.g., a mass flow rate of exhaust output by the engine 104). For example, the LP DC determination module 204 may determine the desired mass flowrate through the LP wastegate 164 using the relationship:

\dot{m}_{LP,WG}=\dot{m}_{ENG}−\dot{m}_{LPT,DES},

where \dot{m}_{LP,WG} is the desired mass flowrate through the LP wastegate 164, \dot{m}_{LPT,DES} is the desired mass flowrate through the LP turbine 152, and \dot{m}_{ENG} is the mass flowrate of the engine 104. The mass flowrate of the engine 104 may be, for example, measured via a mass air flowrate (MAF) sensor or an exhaust flow rate (EFR) sensor or determined based on one or more other parameters.

The LP DC determination module 204 determines the FF LP DC 232 (for the LP wastegate 164) at 324. The LP DC determination module 204 determines the FF LP DC 232 based on the desired mass flowrate through the LP wastegate 164, the pressure at the inlet of the LP turbine 152, and the pressure at the outlet of the LP turbine 152. For example, the LP DC determination module 204 may determine the FF LP DC 232 using the relationship:

FFLPDC=f(p_{LPT,OUT},p_{LPT,IN},\dot{m}_{LP,WG}),

where FFLPDC is the FF LP DC 232, P_{LPT,OUT} is the pressure at the outlet of the LP turbine 152, p_{LPT,IN} is the pressure at the inlet of the LP turbine 152, and \dot{m}_{LP,WG} is the desired mass flowrate through the LP wastegate 164.

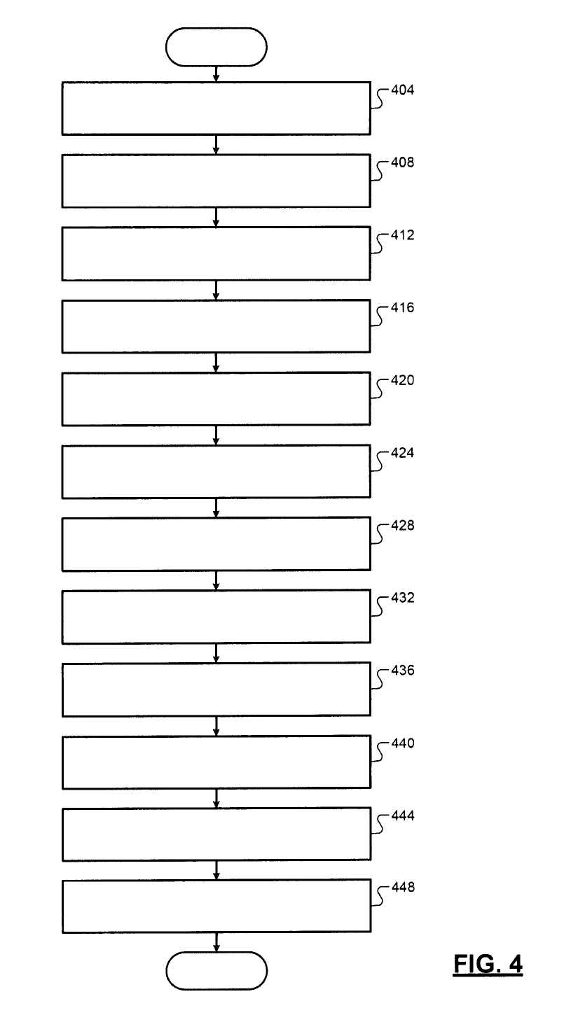

Referring again to FIG. 2, the HP DC determination module 208 determines a FF HP duty cycle (DC) 236 for controlling the HP wastegate 160 (and therefore the HP turbocharger 132). FIG. 4 includes a flowchart depicting an example method of determining the FF HP DC 236 that may be performed by the HP DC determination module 208.

Referring now to FIGS. 2 and 4, at 404, the HP DC determination module 208 determines a desired pressure ratio across the HP compressor 128. The HP DC determination module 208 determines the desired pressure ratio across the HP compressor 128 based on the desired pressure ratio across the LP compressor 120 and a desired pressure ratio across both the LP and HP compressors 120 and 128. For example, the HP DC determination module 208 may determine the desired pressure ratio across the HP compressor 128 using the relationship:

$${PR}_{HPC , DES} = \frac{{PR}_{SYS , DES}}{{PR}_{LPC , DES}} ,$$

where PR_{HPC,DES} is the desired pressure ratio across the HP compressor 128, PR_{SYS,DES} is the desired pressure ratio across both the LP and HP compressors 120 and 128, and PR_{LPC,DES} is the desired pressure ratio across the LP compressor 120. The desired pressure ratio across both the LP and HP compressors 120 and 128 may be determined, for example, from a function that relates the requested torque output of the engine 104 to the desired pressure ratio across both the LP and HP compressors 120 and 128.

At 408, the HP DC determination module 208 determines a desired mass flowrate through the HP compressor 128. The HP DC determination module 208 determines the desired mass flowrate through the HP compressor 128 based on the desired pressure ratio across the HP compressor 128, the desired mass air flowrate into the engine 104, and a mass flowrate through the HP compressor 128 where flow through the HP compressor 128 becomes choked. For example, the HP DC determination module 208 may determine the desired mass flowrate through the HP compressor 128 using the relationships:

$$\{ \begin{matrix}if {PR}_{HPC , DES} <= 1 & {\dot{m}}_{HPC , DES} = 0 \\ if {\dot{m}}_{SYS , DES} > {\dot{m}}_{HPC , CHOKE} & {\dot{m}}_{HPC , DES} = 0 \\ if {\dot{m}}_{SYS , DES} < {\dot{m}}_{HPC , CHOKE} & {\dot{m}}_{HPC , DES} = {\dot{m}}_{SYS , DES}\end{matrix} \} ,$$

where PR_{HPC,DES} is the desired pressure ratio across the HP compressor 128, \dot{m}_{HPC,DES} is the desired mass flowrate through the HP compressor 128, \dot{m}_{SYS,DES} is the desired mass flowrate into the engine 104, and \dot{m}_{HPC,CHOKE} is the mass flowrate through the HP compressor 128 where flow becomes choked. The mass flowrate through the HP compressor 128 where flow becomes choked may be a fixed, calibrated value or may be a variable value.

The HP DC determination module 208 determines a FF desired power input to the HP compressor 128 at 412. The HP DC determination module 208 determines the FF desired power input to the HP compressor 128 based on the desired mass flowrate through the HP compressor 128, a specific heat of the air at the inlet of the HP compressor 128, a temperature of the HP compressor 128, a temperature of the air at the inlet of the HP compressor 128, a pressure of the air at the inlet of the HP compressor 128, and the desired pressure ratio across the HP compressor 128. For example, the HP DC determination module 208 may determine the desired power input to the HP compressor 128 using the relationship:

$${PWR}_{HPC , FF} = {\dot{m}}_{HPC , DES} * {Cp}_{HPC} * {T}_{HPC} * f ( {\dot{m}}_{HPC , DES} * \frac{\sqrt{{T}_{HPC , IN}}}{{p}_{HPC , IN}} , {PR}_{HPC , DES} ) ,$$

where PWR_{HPC,FF} is the FF desired power input to the HP compressor 128, Cp_{LPC,IN} is the specific heat of the air input to the HP compressor 128, \dot{m}_{HPC,DES} is the desired mass flowrate through the HP compressor 128, T_{HPC} is the temperature of the HP compressor 128, T_{HPC,IN} is the temperature of the air at the inlet of the HP compressor 128, p_{HPC,IN} is the pressure of the air at the inlet of the HP compressor 128, and PR_{HPC,DES} is the desired pressure ratio across the HP compressor 128. The specific heat of the air input to the LP compressor 120 may be a fixed, calibrated value or may be a variable value. The temperature of the HP compressor 128, the temperature at the inlet of the HP compressor 128, and the pressure at the inlet of the HP compressor 128 may be measured using sensors or determined based on one or more other parameters.

At 416, the HP DC determination module 208 determines a desired total power for the LP and HP compressors 120 and 128. The HP DC determination module 208 determines the desired total power for the LP and HP compressors 120 and 128 based on the FF desired power input to the HP compressor 128 and the desired power input to the LP compressor 120. For example, the HP DC determination module 208 may determine the desired total power for the LP and HP compressors 120 and 128 using the relationship:

PWR_{TOTAL,DES}=PWR_{LPC,DES}+PWR_{HPC,FF},

where PWR_{TOTAL,DES} is the desired total power for the LP and HP compressors 120 and 128 at the target mass flow rate and pressure ratios, PWR_{LPC,DES} is the desired power input to the LP compressor 120 and PWR_{HPC,FF} is the FF desired power input to the HP compressor 128.

The HP DC determination module 208 determines a present power input to the LP compressor 120 at 420. The HP DC determination module 208 may determine the present power input to the LP compressor 120 based on a present mass air flowrate into the engine 104, a present efficiency of the LP compressor 120, the temperature at the inlet of the LP compressor 120, a present pressure ratio across the LP compressor 120, the specific heat ratio, and the specific heat of the air input to the LP compressor 120. For example, the HP DC determination module 208 may determine the present power input to the LP compressor 120 using the relationship:

$${PWR}_{LPC , PRES} = {\dot{m}}_{SYS} * {Cp}_{LPC , IN} * {T}_{LPC , IN} * \frac{1}{{η}_{LPC}} * ( {( {PR}_{LPC} )}^{\frac{γ - 1}{γ}} - 1 ) ,$$

where PWR_{LPC,PRES} is the present power input to the LP compressor 120, Cp_{LPC,IN} is the specific heat of the air input to the LP compressor 120, γ (gamma) is the specific heat ratio, PR_{LPC} is the present pressure ratio across the LP compressor 120, \dot{m}_{SYS} is the mass air flowrate into the engine 104, and T_{LPC,IN} is the temperature at the inlet of the LP compressor 120. The pressure ratio across the LP compressor 120 may be determined based on a pressure at the inlet of the LP compressor 120 and a pressure at the outlet of the LP compressor 120. The pressure at the inlet of the LP compressor 120, the pressure at the outlet of the LP compressor 120, and the temperature at the inlet of the LP compressor 120 may be measured using sensors or determined based on one or more other parameters.

At 424, the HP DC determination module 208 determines a first desired power input to the HP compressor 128. The HP DC determination module 208 determines the first desired power input to the HP compressor 128 based on the desired total power for the LP and HP compressors 120 and 128 and the present power input to the LP compressor 120. For example, the HP DC determination module 208 may determine the first desired power input to the HP compressor 128 using the relationship:

PWR_{HPC,DES1}=PWR_{TOTAL,DES}−PWR_{LPC,PRES},

where PWR_{HPC,DES1} is the first desired power input to the HP compressor 128, PWR_{TOTAL,DES} is the desired total power for the LP and HP compressors 120 and 128, and PWR_{LPC,PRES} the present power input to the LP compressor 120. The first desired power input to the HP compressor 128 may be referred to as a transient desired power as it is calculated using current system flow parameters.

The HP DC determination module 208 determines a second desired power input to the HP compressor 128 at 428. The HP DC determination module 208 determines the second desired power input to the HP compressor 128 based on the desired mass flowrate through the HP compressor 128, the specific heat of the air at the inlet of the HP compressor 128, the temperature of the HP compressor 128, the temperature of the air at the inlet of the HP compressor 128, the pressure of the air at the inlet of the HP compressor 128, and a surge pressure ratio across the HP compressor 128. For example, the HP DC determination module 208 may determine the second desired power input to the HP compressor 128 using the relationship:

$${PWR}_{HPC , DES 2} = {\dot{m}}_{HPC , DES} * {Cp}_{HPC} * {T}_{HPC} * f ( {\dot{m}}_{HPC , DES} * \frac{\sqrt{{T}_{HPC , IN}}}{{p}_{HPC , IN}} , {PR}_{HPC , SURGE} ) ,$$

where PWR_{HPC,DES2} is the second desired power input to the HP compressor 128, Cp_{LPC,IN} is the specific heat of the air input to the HP compressor 128, \dot{m}_{HPC,DES} is the desired mass flowrate through the HP compressor 128, T_{HPC} is the temperature of the HP compressor 128, T_{HPC,IN} is the temperature of the air at the inlet of the HP compressor 128, p_{HPC,IN} is the pressure of the air at the inlet of the HP compressor 128, and PR_{HPC,SURGE} is the surge pressure ratio across the HP compressor 128. The surge pressure ratio across the HP compressor 128 may correspond to a pressure ratio where the pressure at the outlet of the HP compressor 128 is begins to restrict airflow through the HP compressor 128 (i.e., causes a surge condition). The second desired power input to the HP compressor 128 may be referred to as a feed forward desired power as it is calculated using target system flow parameters and pressure ratios, not the current system flow parameters.

At 432, the HP DC determination module 208 determines a final desired power input to the HP compressor 128. At a given time, the HP DC determination module 208 determines the final desired power input based on one of the first desired power input to the HP compressor 128 and the second desired power input to the HP compressor 128. For example, the HP DC determination module 208 may set the final desired power input equal to the lesser one of the first and second desired power inputs.

The HP DC determination module 208 determines a desired power of the HP turbine 148 corresponding to the desired power input to the HP compressor 128 at 436. The HP DC determination module 208 determines the desired power of the HP turbine 148 based on the final desired power input to the HP compressor 128 and a mechanical efficiency of the HP turbine 148. For example, the HP DC determination module 208 may determine the desired power of the HP turbine 148 using the relationship:

$${PWR}_{HPT , DES} = \frac{{PWR}_{HPC , FDES}}{{η}_{HPT , MECH}} ,$$

where PWR_{HPT,DES} is the desired power of the HP turbine 148, η_{HPT,MECH} is the mechanical efficiency of the HP turbine 148, and PWR_{HPC,FDES} is the final desired power input to the HP compressor 128. The mechanical efficiency of the HP turbine 148 may be a fixed, calibrated value or a variable value (e.g., determined based on temperature of the HP turbine 148).

At 440, HP DC determination module 208 determines a desired mass flowrate through the HP turbine 148 corresponding to the desired power of the HP turbine 148. The HP DC determination module 208 determines the desired mass flowrate through the HP turbine 148 based on the desired power of the HP turbine 148, a specific heat of the gas at the inlet of the HP turbine 148, a temperature of the HP turbine 148, a present efficiency of the HP turbine 148, a pressure ratio across the HP turbine 148, and a third specific heat ratio.

For example, the HP DC determination module 208 may determine the desired mass flowrate through the HP turbine 148 using the relationship:

$${\dot{m}}_{HPT , DES} = {{PWR}_{HPT , DES} [ {Cp}_{HPT , PRES} * {T}_{HPT , PRES} * {η}_{LPT , PRES} * ( 1 - {( {PR}_{HPT , PRES} )}^{\frac{γ - 1}{γ}} ) ]}^{- 1} ,$$

where \dot{m}_{HPT,DES} is the desired mass flowrate through the HP turbine 148, PWR_{HPT,DES} is the desired power of the HP turbine 148, Cp_{LPT,PRES} is the specific heat of the gas that is input to the HP turbine 148, T_{HPT,PRES} is the temperature of the gas at the inlet of the HP turbine 148, PR_{HPT,PRES} is the present pressure ratio across the HP turbine 148, and γ (gamma) is the third specific heat ratio. The specific heat of the gas input to the LP turbine 152 and the third specific heat ratio may be fixed, calibrated values or may be variable values. The pressure ratio across the HP turbine 148 may be determined based on a pressure at the inlet of the HP turbine 148 and a pressure at the outlet of the HP turbine 148. The pressure at the inlet of the HP turbine 148, the pressure at the outlet of the HP turbine 148, and the temperature at the inlet of the HP turbine 148 may be measured using sensors or determined based on one or more other parameters. While present values of temperature and pressure (pressure ratio) are used and described above, predicted or estimated values of the temperature and pressure may be used. The same is true for the case of the LP turbine 152.

At 444, the HP DC determination module 208 determines a desired mass flowrate through the HP wastegate 160. The HP DC determination module 208 determines the desired mass flowrate through the HP wastegate 160 based on the desired mass flowrate through the HP turbine 148 and the mass flowrate of the engine 104 (e.g., the mass flow rate of exhaust output by the engine 104). For example, the HP DC determination module 208 may determine the desired mass flowrate through the HP wastegate 160 using the relationship:

\dot{m}_{HP,WG}=\dot{m}_{ENG}−\dot{m}_{HPT,DES},

where \dot{m}_{HP,WG} is the desired mass flowrate through the HP wastegate 160, \dot{m}_{HPT,DES} is the desired mass flowrate through the HP turbine 148, and \dot{m}_{ENG} is the mass flowrate of the engine 104. The mass flowrate of the engine 104 may be, for example, measured via a mass air flowrate (MAF) sensor or an exhaust flow rate (EFR) sensor or determined based on one or more other parameters.

The HP DC determination module 208 determines the FF HP DC 236 (for the HP wastegate 160) at 448. The HP DC determination module 208 determines the FF HP DC 236 based on the desired mass flowrate through the HP wastegate 160, the pressure at the inlet of the HP turbine 148, and the pressure at the outlet of the HP turbine 148. For example, the HP DC determination module 208 may determine the FF HP DC 236 using the relationship:

FFHPDC=f(p_{HPT,OUT},p_{HPT,IN},\dot{m}_{HP,WG}),

where FFHPDC is the FE HP DC 236, P_{HPT,OUT} is the pressure at the outlet of the HP turbine 148, p_{HPT,IN} is the pressure at the inlet of the HP turbine 148, and \dot{m}_{HP,WG} is the desired mass flowrate through the HP wastegate 160.

Referring again to FIG. 2, the LP targeting module 212 determines the target LP DC 174 based on the FF LP DC 232. The HP targeting module 216 determines the target HP DC 182 based on the FF HP DC 236. The target LP DC 174 and the target HP DC 182 may also be determined based on a LP adjustment 240 and a HP adjustment 244, respectively.

The adjustment determination module 220 determines the LP adjustment 240. The adjustment determination module 220 may determine the LP adjustment 240, for example, based on a desired pressure 248 between the LP compressor 120 and the HP compressor 128 and a pressure 252 between the LP compressor 120 and the HP compressor 128. Alternatively, the adjustment determination module 220 may determine the LP adjustment 240 based on a desired pressure 256 output from the HP compressor 128 and a pressure 260 output from the HP compressor 128. The pressure 252 between the LP compressor 120 and the HP compressor 128 and the pressure 260 output from the HP compressor 128 may be measured or estimated or predicted based on one or more other measured parameters.

The adjustment determination module 220 may determine the LP adjustment 240 based on a difference between (1) the desired pressure 248 between the LP compressor and the HP compressor 128 and (2) the pressure 252 between the LP compressor and the HP compressor 128. When the desired pressure 256 output from the HP compressor 128 and the pressure 260 output from the HP compressor 128 are used, the adjustment determination module 220 may determine the LP adjustment 240 based on a difference between (1) the desired pressure 256 output from the HP compressor 128 and (2) the pressure 260 output from the HP compressor 128. For example only, the adjustment determination module 220 may include a proportional (P), a proportional integral (PI), or a proportional integral derivative (PID) module and may determine the LP adjustment 240 based on the difference using the P, PI, or PID module.

The adjustment determination module 220 also determines the HP adjustment 244. The adjustment determination module 220 may determine the HP adjustment 244, for example, based on the desired pressure 256 output from the HP compressor 128 and the pressure 260 output from the HP compressor 128. The adjustment determination module 220 may determine the HP adjustment 244 based on the difference between the desired pressure 256 output from the HP compressor 128 and the pressure 260 output from the HP compressor 128. For example only, the adjustment determination module 220 may include a second proportional (P), a proportional integral (PI), or a proportional integral derivative (PID) module and may determine the HP adjustment 244 based on the difference between the desired pressure 256 output from the HP compressor 128 and the pressure 260 output from the HP compressor 128 using the P, PI, or PID module.

The LP targeting module 212 sets the target LP DC 174 equal to a sum of the LP adjustment 240 and the FF LP DC 232. The HP targeting module 216 sets the target HP DC 182 equal to a sum of the FF HP DC 236 and the HP adjustment 244. The LP wastegate actuator module 186 applies a signal to the LP wastegate 164 at the duty cycle specified by the target LP DC 174. The HP wastegate actuator module 178 applies a signal to the HP wastegate 160 at the duty cycle specified by the target HP DC 182.

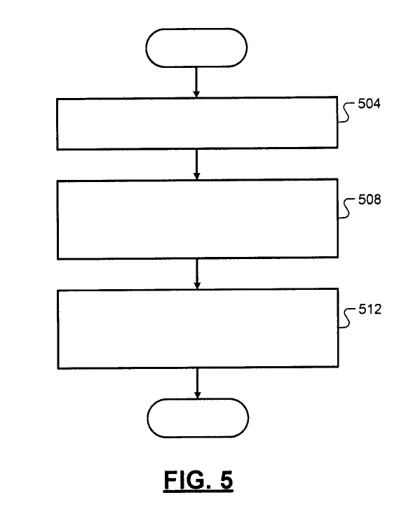

FIG. 5 includes a flowchart depicting an example method of determining the target LP and HP DCs 174 and 182 and controlling the LP and HP turbochargers 124 and 132. Referring now to FIGS. 2 and 5, at 504, the HP and LP FF DCs 236 and 232 are determined as described above. Also at 504, the adjustment determination module 220 determines the LP and HP adjustments 240 and 244 as described above.

At 508, the LP targeting module 212 sets the target LP DC 174 equal to the sum of the FF LP DC 232 and the LP adjustment 240, and the HP targeting module 216 sets the target HP DC 182 equal to the sum of the FF HP DC 236 and the HP adjustment 244.

At 512, the LP wastegate actuator module 186 regulates opening of the LP wastegate 164 based on the target LP DC 174, and the HP wastegate actuator module 178 regulates opening of the HP wastegate 160 based on the target HP DC 182. The opening of the LP wastegate 164 regulates boost provided by the LP turbocharger 124, and the opening of the HP wastegate 160 regulates boost provided by the HP turbocharger 132. More specifically, as the opening of a wastegate increases, boost provided by the associated turbocharger decreases, and vice versa. While FIG. 5 is shown as ending after 512, FIG. 5 may be illustrative of one control loop, and control loops may be performed at predetermined intervals (e.g., once every 25 milliseconds or another suitable rate).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A turbocharger control system of a vehicle, comprising:
a first duty cycle determination module that determines a first desired pressure ratio across a first compressor of a first turbocharger and that, based on the first desired pressure ratio, determines a first desired duty cycle for a first wastegate of the first turbocharger;
a second duty cycle determination module that determines a second desired pressure ratio across a second compressor of a second turbocharger based on the first desired pressure ratio and that, based on the second desired pressure ratio, determines a second desired duty cycle for a second wastegate of the second turbocharger;
a first targeting module that generates a first target duty cycle for the first wastegate of the first turbocharger based on the first desired duty cycle and that opens the first wastegate of the first turbocharger based on the first target duty cycle; and
a second targeting module that generates a second target duty cycle for the second wastegate of the second turbocharger based on the second desired duty cycle and that opens the second wastegate of the second turbocharger based on the second target duty cycle.

2. The turbocharger control system of claim 1 further comprising an adjustment determination module that determines a first adjustment for the first wastegate of the first turbocharger and that determines a second adjustment for the second wastegate of the second turbocharger,
wherein the first targeting module selectively generates the first target duty cycle further based on the first adjustment, and
wherein the second targeting module selectively generates the second target duty cycle further based on the second adjustment.

3. The turbocharger control system of claim 2 wherein the first targeting module sets the first target duty cycle equal to a sum of the first desired duty cycle and the first adjustment.

4. The turbocharger control system of claim 2 wherein the second targeting module sets the second target duty cycle equal to a sum of the second desired duty cycle and the second adjustment.

5. The turbocharger control system of claim 2 wherein:
the first targeting module sets the first target duty cycle equal to a sum of the first desired duty cycle and the first adjustment; and
the second targeting module sets the second target duty cycle equal to a sum of the second desired duty cycle and the second adjustment.

6. The turbocharger control system of claim 2 wherein the adjustment determination module determines the first adjustment based on a first desired pressure output from the first compressor of the first turbocharger.

7. The turbocharger control system of claim 6 wherein the adjustment determination module determines the second adjustment based on a second desired pressure output from the second compressor of the second turbocharger.

8. The turbocharger control system of claim 7 wherein the adjustment determination module:
determines the first adjustment further based on a pressure output from the first compressor of the first turbocharger; and
determines the second adjustment further based on a pressure output from the second compressor of the second turbocharger.

9. The turbocharger control system of claim 8 wherein the adjustment determination module:
determines the first adjustment based on a difference between the first desired pressure output from the first compressor of the first turbocharger and the pressure output from the first compressor of the first turbocharger; and
determines the second adjustment based on a difference between the second desired pressure output from the second compressor of the second turbocharger and the pressure output from the second compressor of the second turbocharger.

10. The turbocharger control system of claim 1 further comprising:
a first actuator module that applies a first signal having a duty cycle equal to the first target duty cycle to the first wastegate; and
a second actuator module that applies a second signal having a duty cycle equal to the second target duty cycle to the second wastegate.

11. A turbocharger control method of a vehicle, comprising:
determining a first desired pressure ratio across a first compressor of a first turbocharger;
based on the first desired pressure ratio, determining a first desired duty cycle for a first wastegate of the first turbocharger;
determining a second desired pressure ratio across a second compressor of a second turbocharger based on the first desired pressure ratio;
based on the second desired pressure ratio, determining a second desired duty cycle for a second wastegate of the second turbocharger;
generating a first target duty cycle for the first wastegate of the first turbocharger based on the first desired duty cycle;
opening the first wastegate of the first turbocharger based on the first target duty cycle;
generating a second target duty cycle for the second wastegate of the second turbocharger based on the second desired duty cycle; and
opening the second wastegate of the second turbocharger based on the second target duty cycle.

12. The turbocharger control method of claim 11 further comprising:
determining a first adjustment for the first wastegate of the first turbocharger;
determining a second adjustment for the second wastegate of the second turbocharger;
selectively generating the first target duty cycle further based on the first adjustment; and
selectively generating the second target duty cycle further based on the second adjustment.

13. The turbocharger control method of claim 12 further comprising setting the first target duty cycle equal to a sum of the first desired duty cycle and the first adjustment.

14. The turbocharger control method of claim 12 further comprising setting the second target duty cycle equal to a sum of the second desired duty cycle and the second adjustment.

15. The turbocharger control method of claim 12 further comprising:
setting the first target duty cycle equal to a sum of the first desired duty cycle and the first adjustment; and
setting the second target duty cycle equal to a sum of the second desired duty cycle and the second adjustment.

16. The turbocharger control method of claim 12 further comprising determining the first adjustment based on a first desired pressure output from the first compressor of the first turbocharger.

17. The turbocharger control method of claim 16 further comprising determining the second adjustment based on a second desired pressure output from the second compressor of the second turbocharger.

18. The turbocharger control method of claim 17 further comprising:
determining the first adjustment further based on a pressure output from the first compressor of the first turbocharger; and
determining the second adjustment further based on a pressure output from the second compressor of the second turbocharger.

19. The turbocharger control method of claim 18 further comprising:
determining the first adjustment based on a difference between the first desired pressure output from the first compressor of the first turbocharger and the pressure output from the first compressor of the first turbocharger; and
determining the second adjustment based on a difference between the second desired pressure output from the second compressor of the second turbocharger and the pressure output from the second compressor of the second turbocharger.

20. The turbocharger control method of claim 11 further comprising:
applying a first signal having a duty cycle equal to the first target duty cycle to the first wastegate; and
applying a second signal having a duty cycle equal to the second target duty cycle to the second wastegate.
